(19) United States
(12) Patent Application Publication
(10) Pub. No.: US 2024/0045061 A1
(43) Pub. Date: Feb. 8, 2024

(54) ACQUISITION OF DISTANCES FROM A SENSOR TO A SCENE

(71) Applicant: Commissariat à l'Energie Atomique et aux Energies Alternatives, Paris (FR)

(72) Inventors: Josep SEGURA PUCHADES, Grenoble (FR); Laurent FREY, Grenoble (FR); Anis DAAMI, Grenoble (FR)

(21) Appl. No.: 18/354,728

(22) Filed: Jul. 19, 2023

(30) Foreign Application Priority Data
Jul. 29, 2022 (FR) 2207829

(51) Int. Cl. G01S 17/32; G01S 7/481; G01S 7/4911

(52) U.S. Cl. CPC G01S 17/32; G01S 7/4816; G01S 7/4911

(57) ABSTRACT

The present description concerns a method of acquisition of distances from a sensor to a scene, comprising a number N of consecutive capture sub-phases Cᵢ, with N an integer greater than or equal to 2 and i an integer index ranging from 1 to N, each sub-phase Cᵢ comprising: supplying a laser beam having an optical frequency (f) linearly varying over a frequency range of width Bᵢ for a time period Tᵢ; delivering, from the laser beam, a reference beam and a useful beam; and illuminating the scene with the useful beam and illuminating at least one pixel row with a superposition of the reference beam and of a reflected beam. An absolute value of a ratio Bᵢ/Tᵢ is different for each capture sub-phase Cᵢ.

### FIELD

The present disclosure generally concerns electronic circuits, and more particularly distance sensors, for example used to obtain a depth map of a scene, that is, for each pixel of the sensor, a distance from this pixel to a point in the scene corresponding to the pixel.

### BACKGROUND

Sensors for obtaining a depth map of a scene, that is, a three-dimensional image of the scene, are known.

Among these known sensors, sensors operating according to the LIDAR (“Laser Imaging Detection and Ranging”) technique of FMCW (“Frequency Modulated Continuous Wave”) type can be distinguished.

FIG. 1 schematically illustrates a sensor 1 implementing the principle of the FMCW-type LIDAR technique. More detailed examples of sensors using the FMCW-type LIDAR technique may be found in literature, for example, in patent application FR3106417.

Sensor 1 comprises a source 100 of a laser beam 102.

Sensor 1 comprises an optical device 104 configured to deliver, from laser beam 102, a useful laser beam 106 and a reference laser beam 108. Laser 106 for example corresponds to a portion of beam 102, beam 108 for example corresponding to the other portion of beam 102.

Useful beam 106 is emitted towards a scene 110 to be imaged. In other words, beam 106 is used to illuminate scene 110. The reflection of beam 106 by scene 110 results in a reflected beam 112 which propagates from scene 110 to sensor 1.

Sensor 1 comprises an optical device 114 configured to superpose, or combine, reference beam 108 with the reflected beam 112. Thus, device 114 receives the two beams 108 and 112.

A beam 116 resulting from the combination of beams 108 and 112 is supplied by device 114 to at least one pixel Pix of sensor 1. Due to the fact that beam 102 is a coherent light beam, beam 108 is used as an amplifier of the reflected beam. In FIG. 1, a single pixel Pix is shown, although sensor 1 may in practice comprise a large number thereof, for example, more than 100,000, or even more than 300,000.

Pixel Pix comprises a photodetector PD, for example, a photodiode. Pixel Pix is configured so that its photodetector PD supplies a heterodyne signal i_{PD}, for example, a photocurrent, having its amplitude depending on the intensity of the received bema 116.

In LIDAR techniques of FMCW type, source 100 is controlled by sensor 1, for example, by a control circuit 118 of sensor 1, to modulate the optical frequency f of laser beam 102. More particularly, source 100 is controlled, or configured, so that the frequency f of beam 102 is modulated over a frequency range of width or excursion B for a time period T. In other words, source 100 is configured, during a phase of capture of scene 110, so that the optical frequency f of beam 102 varies linearly during time period T, from a first frequency to a second frequency separated from the first frequency by value B. Still in other words, T is the duration of the continuous modulation of the optical frequency f of beam 102, and B is the excursion or the amplitude of this modulation (also called chirp).

FIG. 2 schematically shows the principle of this frequency modulation.

More particularly, a straight line 200 shows the variation of the optical frequency f of beam 102 during time period T. The amplitude of the modulation of frequency f during time period T is B.

Reference beam 108 originating from beam 102, its optical frequency is modulated like that of beam 102. Straight line 200 thus also represents the variation of the optical frequency of beam 108 during time period T.

Similarly, beam 106 also originating from beam 102, its optical frequency is modulated like that of beam 102, whereby the reflected beam 112 also has its optical frequency modulated like that of beam 102. However, as compared with reference beam 108, beam 112 has traveled twice the distance z from sensor 1 to scene 110. Thus, when the frequency f of beam 108 has a given value, the beam 112 received by sensor 1 is at this given frequency f with a delay Δt determined by distance z as shown by a straight line 202 of FIG. 2 (in dotted lines in FIG. 2).

The superposition, by component 114, of the reflected beam 112 with reference beam 108 results in interferences in beam 116, which generate beats at a frequency F_{R} depending on delay Δt, and thus on distance z. These beats at frequency F_{R} can be found in signal i_{PD}. FIG. 3 illustrates the beats at frequency F_{R} of heterodyne signal i_{PD}.

More particularly, frequency F_{R} is determined by the following formula: F_{R}=(2*B*z)/(c*T), with * the multiply operator, B the excursion of the modulation of the optical frequency f of beam 102 during time period T, T the duration of the frequency modulation, c the speed of light, and z the distance from sensor 1 to the scene, and more particularly from the concerned pixel Pix to the scene. Thus, it is sufficient to measure the frequency F_{R} of the heterodyne signal i_{PD} of a pixel Pix of sensor 1 to know the distance z separating this pixel Pix from the point in the scene which is associated with this pixel Pix.

This measurement of beat frequency F_{R} may be performed by fast Fourier transform (FFT). The FFT measurement method is however not adapted to sensors comprising a large number of pixels, for example, more than 100,000 pixels, or even more than 300,000 pixels, where the measurement of frequency F_{R} must be implemented simultaneously for all the pixels of the sensor in snapshot mode or for all the pixels of a row of the array of pixels in rolling mode, if a rate of acquisition of images of the scene of at least 30 images per second is targeted.

The measurement of beat frequency F_{R} may also be performed by counting the number M or periods Te of the heterodyne signal over a given time period, for example, the duration T of the modulation of the frequency f of beam 102. In this case, it can be considered that frequency F_{R} is equal to M/T, neglecting the uncertainty on the counted number M and neglecting the optical path traveled in sensor 1 by reference beam 108 with respect to beam 106, 112, and thus, that z is equal to (M*c)/(2*B). The resolution for z, noted ∂z, is then equal to c/(2*B). This method of measurement of frequency F_{R} by counting is simple to implement and enables to obtain a measurement of frequency F_{R} faster than with the FFT method. However, it is desirable for the signal-to-noise ratio SNR to be as high as possible to avoid counting errors.

### SUMMARY

There is a need to overcome all or part of the disadvantages of known methods of acquisition of the distances from a sensor to a scene, in particular of known methods based on the LIDAR technique of FCMW type.

An embodiment overcomes all or part of the disadvantages of known methods of acquisition of the distances from a sensor to a scene, in particular of known methods based on the LIDAR technique of FCMW type.

An embodiment provides a method of acquisition of distances from a sensor to a scene, the method comprising, during a phase of capture of the scene, a number N of consecutive capture sub-phases Cᵢ, with N an integer greater than or equal to 2 and i an integer index ranging from 1 to N, each of the capture sub-phases Cᵢ comprising:
the supplying of a laser beam having an optical frequency linearly varying over a frequency range of width Bᵢ for a time period Tᵢ;
the supplying based on said laser beam of a reference beam and of a useful beam; and
the illumination of the scene by the useful beam and the illumination of at least one row of pixels of the sensor by a beam corresponding to a superposition of the reference beam and of a reflected beam corresponding to the reflection of the useful beam by the scene,
wherein an absolute value of a ratio Bᵢ/Tᵢ is different for each capture sub-phase Cᵢ,
wherein each capture sub-phase Cᵢ corresponds to a range Dzᵢ of measurement of distances from the sensor to the scene, range Dzᵢ ranging from zminᵢ to zmaxᵢ with zmaxᵢ greater than zminᵢ, ratios Bᵢ/Tᵢ being determined so that for i ranging from 1 to N−1, zmin₁₊ᵢ is substantially equal to zmaxᵢ without being greater than zmaxᵢ.

According to an embodiment, ratios Bᵢ/Tᵢ are determined so that for i ranging from 1 to N−1, zmin₁₊ᵢ is equal to zmaxᵢ.

According to an embodiment, for each measurement sub-phase Cᵢ and for each pixel of the sensor, the illumination of the pixel by the beam corresponding to the superposition of the reference beam and of the reflected beam results in a signal oscillating at a beat frequency F_{R}i belonging to a frequency range ΔF_{R}i ranging from a frequency F_{R}infᵢ to a frequency F_{R}supᵢ if a point in the scene associated with said pixel is at a distance from the pixel within range Dzᵢ.

According to an embodiment, for i ranging from 1 to N, F_{R}supᵢ is equal to Kᵢ times F_{R}infᵢ, with Kᵢ a coefficient, and frequency F_{R}infᵢ is identical for all indexes i in the range from 1 to N.

According to an embodiment, Kᵢ is identical for all indexes i in the range from 1 to N.

According to an embodiment, for each capture sub-phase Cᵢ and each pixel of the sensor, if the beat frequency F_{R}i is within frequency range ΔF_{R}i, a distance z from the pixel to the point in the scene associated with the pixel is calculated based on the following formula: z=(c·Tᵢ·F_{R}i)/(2·Bᵢ), with c the speed of light.

According to an embodiment, for each pixel and at each capture sub-phase Cᵢ, a measurement of the frequency F_{R}i of a pixel is obtained by counting, during the duration Tᵢ of said sub-phase Cᵢ, a number of periods of the oscillating signal of said pixel.

According to an embodiment, for each pixel and for each capture sub-phase Cᵢ, the pixel is at a distance from the point in the scene associated with this pixel within measurement range Dzᵢ if the number of periods counted during the duration Tᵢ of sub-phase Cᵢ belongs to a range of values ranging from a low value Mminᵢ to a high value Mmaxᵢ, the low value being equal to Tᵢ*F_{R}infᵢ and the high value being equal to Tᵢ*F_{R}supᵢ.

According to an embodiment, for i ranging from 1 to N, each range Dzᵢ has a width equal to a targeted distance measurement resolution.

According to an embodiment, for i ranging from 1 to N, each range Dzᵢ has a width equal to a targeted distance measurement resolution, and, for each pixel and for each capture sub-phase Cᵢ, the pixel is at a distance from the point in the scene associated with this pixel within measurement range Dzᵢ if the number of periods counted during the duration Tᵢ of sub-phase Cᵢ is equal to a number determined by this targeted resolution.

According to an embodiment, each range Dzᵢ has a width equal to a targeted distance measurement resolution, and, for each pixel and for each capture sub-phase Cᵢ, a determination that beat frequency F_{R}i is within frequency range ΔF_{R}i is performed by detecting a given frequency of range ΔF_{Ri}.

According to an embodiment, for i ranging from 1 to N, Tᵢ is equal to T/N with T a duration of a phase of simultaneous acquisition by all the sensor pixels, or of a phase of acquisition by a single pixel row of a pixel array of the sensor.

According to an embodiment, for each capture sub-phase Cᵢ, the optical frequency of the laser beam varies from fstartᵢ to fendᵢ, for i ranging from 1 to N−1, fendᵢ is equal to fstartᵢ₊₁ and a sign of coefficient Bᵢ/Tᵢ changes at each passage from a current capture sub-phase Cᵢ to a next capture sub-phase Cᵢ.

An embodiment provides a sensor configured to implement the above method, the sensor comprising:
an array of pixels,
a source of a laser beam,
an optical device configured to supply a reference beam and a useful beam intended to illuminate a scene to be captured,
an optical device configured to simultaneously supply at least one pixel row with a beam corresponding to a superposition of the reference beam and of a beam reflected by the scene when it is illuminated by the useful beam, and
a circuit for controlling the source, configured to modulate an optical frequency of the laser beam supplied by the source so that at each capture sub-phase Cᵢ, the optical frequency of the beam varies linearly over the frequency range of width Bᵢ during time period Tᵢ.

An embodiment provides a sensor comprising:
an array of pixels,
a source of a laser beam,
an optical device configured to supply a reference beam and a useful beam intended to illuminate a scene to be captured,
an optical device configured to simultaneously supply all the pixels with a beam corresponding to a superposition of the reference beam and of a beam reflected by the scene when it is illuminated by the useful beam; and
a circuit for controlling the source, configured to modulate an optical frequency of the laser beam supplied by the source so that at each capture sub-phase Cᵢ, the optical frequency of the beam varies linearly over the frequency range of width Bᵢ during time period Tᵢ;
the sensor being configured to implement the above-described method where each range Dzᵢ has a width equal to a targeted distance measurement resolution, and, for each pixel and for each capture sub-phase Cᵢ, a determination that the beat frequency F_{R}i is within frequency range ΔF_{R}i is performed by detecting a given frequency of range ΔF_{R}i,
the sensor comprising an event management circuit, and each pixel comprising a circuit configured to detect the given frequency and a circuit configured to supply at least one event signal to the event management circuit if, during a sub-phase Cᵢ, the given frequency is detected.

Another embodiment provides a sensor comprising:
an array of pixels;
a source of a laser beam;
an optical device configured to supply a reference beam and a useful beam intended to illuminate a scene to be captured;
an optical device configured to simultaneously supply all the pixels with a beam corresponding to a superposition of the reference beam and of a beam reflected by the scene when it is illuminated by the useful beam; and
a circuit for controlling the source, configured to modulate an optical frequency of the laser beam supplied by the source so that at each capture sub-phase Cᵢ, the optical frequency of the beam varies linearly over the frequency range of width Bᵢ during time period Tᵢ;
the sensor being configured to implement the above-described method wherein for i ranging from 1 to N, each range Dzᵢ has a width equal to a targeted distance measurement resolution, and, for each pixel and for each capture sub-phase Cᵢ, the pixel is at a distance from the point in the scene associated with this pixel within measurement range Dzᵢ if the number of periods counted during the duration Tᵢ of sub-phase Cᵢ is equal to a number determined by this targeted resolution, the sensor comprising an event management circuit, and
each pixel comprising a circuit configured to supply at least one event signal to the event management circuit if, during a sub-phase Cᵢ, the number of periods counted during the duration Tᵢ of sub-phase Cᵢ is equal to the number determined by the targeted resolution.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1, previously described, schematically illustrates an example of a sensor using the LIDAR technology of FCMW type;

FIG. 2, previously described, illustrates the modulation of the optical frequency of a reference laser beam and of a reflected laser beam in the sensor of FIG. 1;

FIG. 3, previously described, illustrates beats of the heterodyne signal obtained by superposing the reference and reflected beams in the sensor of FIG. 1;

FIG. 4 illustrates with curves an embodiment of a method of acquisition of the distances from a sensor to a scene based on the FCMW LIDAR technique;

FIG. 5 illustrates with curves an alternative embodiment of a method of acquisition of the distances from a sensor to a scene based on the FCMW LIDAR technique;

FIG. 6 schematically shows an embodiment of a sensor implementing the method of FIG. 4 or of FIG. 5; and

FIG. 7 shows another embodiment of a sensor implementing the method of FIG. 4 or of FIG. 5.

### DETAILED DESCRIPTION OF THE PRESENT EMBODIMENTS

Like features have been designated by like references in the various figures. In particular, the structural and/or functional features that are common among the various embodiments may have the same references and may dispose identical structural, dimensional and material properties.

For the sake of clarity, only the steps and elements that are useful for an understanding of the embodiments described herein have been illustrated and described in detail. In particular, known pixels of known sensors allowing the implementation of a method of acquisition of distances from a sensor to a scene have not been detailed, the described embodiments and variants being compatible with these known pixels and sensors.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, when reference is made to absolute positional qualifiers, such as the terms “front”, “back”, “top”, “bottom”, “left”, “right”, etc., or to relative positional qualifiers, such as the terms “above”, “below”, “upper”, “lower”, etc., or to qualifiers of orientation, such as “horizontal”, “vertical”, etc., reference is made, unless specified otherwise, to the orientation of the figures.

Unless specified otherwise, the expressions “around”, “approximately”, “substantially” and “in the order of” signify within 10%, and preferably within 5%.

There has been previously described a sensor 1 where, for each pixel Pix of sensor 1, the frequency F_{R} of the heterodyne signal of pixel Pix is measured by counting the number M of periods Te of the signal for a given time period, for example, duration T of modulation of the optical frequency f of beam 102.

In a known sensor 1, the excursion B of the frequency modulation and the duration T of this modulation are fixed and constant. This implies that, to detect a distance z from a pixel Pix to an associated point in the scene which is between a minimum value zmin and a maximum value zmax, frequency F_{R} has to be measurable over the entire extension of a range ΔF_{R} from a minimum beat frequency F_{R}min determined by value zmin to a maximum beat frequency F_{R}max determined by value zmax. ΔF_{R} thus is the bandwidth of the signal to be measured. Bandwidth ΔF_{R} is equal to (2*(zmax-zmin)*B)/(c*T).

When the distance range to be measured or detected increases, bandwidth ΔF_{R} also increases. The increase of ΔF_{R} implies increasing the bandwidth of the circuit(s) of amplification of signal i_{PD} accordingly, which increases the noise or the power consumption of this or these circuit(s). The increase of bandwidth ΔF_{R} further implies an increase of the photonic noise of the DC (“Direct Current”) component of signal i_{PD}. The increase of the DC component of signal i_{PD}results in a decrease of the signal-to-noise ratio. Indeed, the ratio of the DC component i_{PDDC} of signal i_{PD} to the useful signal i_{PDAC} of signal i_{PD} may then exceed a factor 20. Now, neglecting the photonic noise of the useful signal i_{PDAC}, signal-to-noise ratio SNR is equal to:

$$\frac{1}{\sqrt{q Δ {F}_{R} \prod }} \frac{{i}_{PDAC}}{\sqrt{{i}_{PDDC}}}$$

with q the charge of an electron.

As already previously indicated, the method of determining frequency F_{R} by counting is sensitive to the signal-to-noise ratio, and a decrease of this ratio may result in erroneous countings due to the noise, and thus to erroneous values of M.

To decrease bandwidth ΔF_{R} so as to increase the signal-to-noise ratio, while keeping the same dynamic range Δz=zmax-zmin for the measurement of z, it is here provided, during a phase of capture of a scene, for example, by sensor 1, to divide the acquisition duration T into N consecutive time intervals Tᵢ, with i an integer index ranging from 1 to N and N an integer greater than 2. Each capture interval or sub-phase Cᵢ corresponds to the delivery of a beam 102 having its optical frequency f continuously and linearly modulated over a frequency range of width Bᵢ for the duration Tᵢ of this sub-phase. In other words, the N sub-phases Cᵢ are consecutive and, during each sub-phase Cᵢ, source 100 is controlled so that the optical frequency f of beam 102 is continuously and linearly modulated with a frequency excursion Bᵢ during time period Tᵢ. Further, it is provided for each sub-phase Cᵢ to correspond to a ratio Bᵢ/Tᵢ having an absolute value different from that of the ratios Bᵢ/Tᵢ of the N−1 other sub-phases Cᵢ.

Thereby, it can be provided for each sub-phase Cᵢ to correspond to a bandwidth ΔF_{R}i decreased with respect to bandwidth ΔF_{R} and, further, for each sub-phase Cᵢ to enable to detect, or measure, distances z comprised within a corresponding range Dzᵢ ranging from a minimum value zminᵢ to a maximum value zmaxᵢ. The bandwidth ΔF_{R}i of each of sub-phases Cᵢ extends from a minimum frequency F_{R}infᵢ to a maximum frequency F_{R}supᵢ.

For example, for each sub-phase Cᵢ, F_{R}supᵢ is equal to Kᵢ times F_{R}infᵢ. Preferably, Kᵢ has the same value for all sub-phases Cᵢ. However, in other examples, the values Kᵢ of at least two sub-phases Cᵢ may be different.

As an example, frequency F_{R}supᵢ has the same value for all sub-phases Cᵢ or frequency F_{R}infᵢ has the same value for all sub-phases Cᵢ. Preferably, frequency F_{R}supᵢ has the same value for all sub-phases Cᵢ and frequency F_{R}infᵢ has the same value for all sub-phases Cᵢ, or, in other words, all sub-phases Cᵢ have the same bandwidth ΔF_{R}i, and thus the same coefficient Kᵢ.

The range Dzᵢ of each sub-phase Cᵢ is different from that of the other sub-phases Cᵢ, so that, by placing the N ranges Dzᵢ end to end, sensor 1 is capable of detecting the distances z between zmin and zmax. According to an embodiment, ratios Bᵢ/Tᵢ are determined so that ranges Dzᵢ can be placed end to end to obtain a dynamic range for z from zmin to zmax. In other words, ratios Bᵢ/Tᵢ are at least partly determined by the targeted measurement dynamic range zmax-zmin.

For example, according to an embodiment where sub-phases Cᵢ are implemented by order of increasing index i, ratios Bᵢ/Tᵢ are determined so that, for i varying from 1 to N−1, value zmin₁₊ᵢ is equal to value zmaxᵢ. In a variant, ranges Dzᵢ may partially overlap, and, in this case, for i varying from 1 to N−1, zmin₁₊ᵢ is substantially equal to but not greater than value zmaxᵢ. However, the embodiment where zmin₁₊ᵢ is equal to zmaxᵢ has the advantage of not detecting or measuring a same distance value z in two different sub-phases Cᵢ.

For a given sub-phase Cᵢ and for a given pixel, a beat frequency F_{R}i in the range from F_{R}infᵢ to F_{R}supᵢ can be observed if the point associated with the pixel is at a distance z from the pixel in the range from zminᵢ to zmaxᵢ. Further, distance z can then be calculated based on the following formula:
z=(c·Tᵢ·F_{R}i)/(2·Bᵢ), where F_{R}i is the measured beat frequency of the heterodyne signal of the pixel and is equal to M/Tᵢ with M the counted number of periods of the heterodyne signal during time period Tᵢ.

In sensor 1, when a phase of capture of a scene comprises N sub-phases Cᵢ such as described in the present application, sensor 1 is, according to an embodiment, configured so that beam 116 simultaneously illuminates all the sensor pixels Pix. However, in alternative embodiments, when sensor 1 operates in rolling mode, the sensor may be configured so that beam 116 only illuminates the pixels Pix of the row for which the acquisition in going on.

An example of a method of calculation of ratios Bᵢ/Tᵢ will now be described.

In this example, it is considered that durations Tᵢ are all identical and are for example equal to T/N. The frequency excursions Bᵢ are thus different for each sub-phase Cᵢ. Duration T corresponds, for example, to the duration T of continuous modulation of laser beam 102 over a frequency excursion B which would be necessary to measure distances z in the range from zmin to zmax.

In this example, it is further considered that, for i varying from 1 to N−1, zmaxᵢ=zminᵢ.i, to obtain a continuous range of measurable distances when ranges Dzᵢ are placed end-to-end. In other words, (c·Tᵢ·F_{R}supᵢ)/(2·Bᵢ)=(c·Tᵢ±1·F_{R}infᵢ+1)/(2·Bᵢ±1). Since Tᵢ is equal to T,±i, as a result, F_{R}supᵢ/F_{R}infᵢ+1=Bᵢ/Bᵢ.

As an example, by making the choice for F_{R}infᵢ to be identical for each sub-phase Cᵢ, and knowing that F_{R}supᵢ is equal to Kᵢ times F_{R}infᵢ, one thus obtains Bᵢ/B;±i=zmaxᵢ/zminᵢ=Kᵢ.

It is then possible to calculate Bᵢ, then B₂ equal to Bᵢ divided by Kᵢ, then B₃ equal to B₂ divided by K₂, and so on until B_{N} and zmax_{N} are obtained, so that the total dynamic range of measurement of z equal to zmax/zmin is equal to zmax_{N}/zminᵢ. Value N is then, for example, at least partly determined by the selection of coefficients Kᵢ.

As a more specific example, in addition to the choice of a frequency F_{R}infᵢ identical for each sub-phase Cᵢ, Kᵢ is selected to be identical and equal to K for all sub-phases Cᵢ. In this case, sub-phases Cᵢ all have the same frequency F_{R}infᵢ, the same frequency F_{R}supᵢ, and the same bandwidth ΔF_{R}i. As a result, zmax/zmin=zmax_{N}/zminᵢ=K^{N}. N then is, for example, calculated by applying the base-K logarithmic function to the zmax/zmin dynamic range, N for example being equal to the rounded integer above the value obtained by applying the base-K logarithm to zmax/zmin.

It is thus possible, in this more specific example and using the equations given hereabove, to determine the N coefficients Bᵢ.

For example, knowing zmin and zmax and setting the value of K, the number N of sub-phases is obtained, and then, knowing measurement time T, the duration Tᵢ of each sub-phase Cᵢ is obtained. By then setting frequency F_{R}infᵢ, it is possible to calculate B₁, knowing that B₁=(F_{R}infᵢ·c·Tᵢ)/(2.zmin). As a variant, rather than setting frequency F_{R}infᵢ, a minimum number Mmin of periods of the heterodyne signal to be detected in each sub-phase Cᵢ is set so that the point associated with the pixel belongs to the measurement range Dzᵢ of this sub-phase Cᵢ, and it is then possible to calculate B₁ knowing that B₁=(Mmin·c)/(2.zmin). The other coefficients Bᵢ are then, for example, calculated by means of the following equation: Bᵢ=B₁/K⁽ⁱ⁻¹⁾.

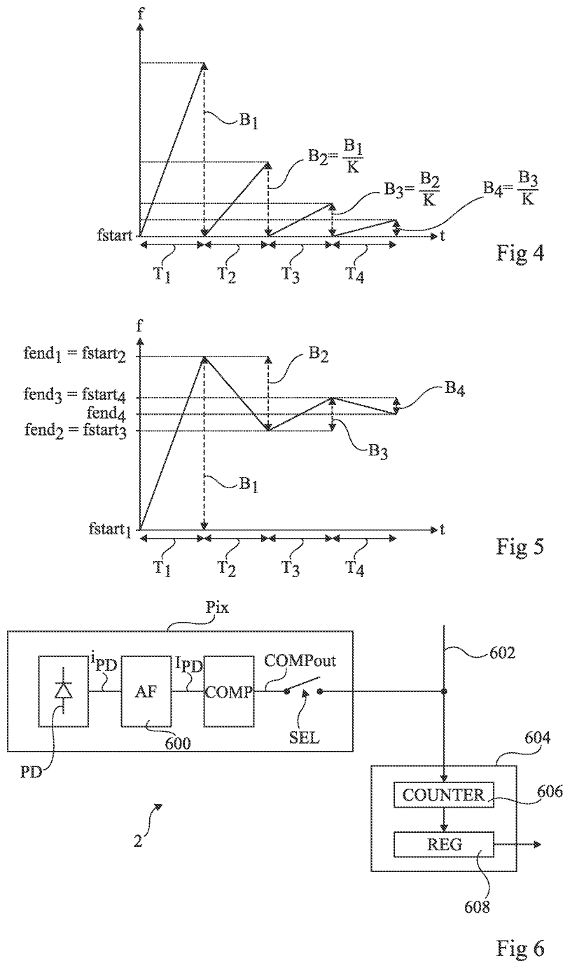

FIG. 4 illustrates an example of implementation in the case where N is equal to 4, Tᵢ is identical for all sub-phases Cᵢ, Kᵢ is identical and equal to K for all sub-phases Cᵢ, and ΔF_{R}i is identical for all sub-phases Cᵢ. In FIG. 4, the axis of abscissas represents time t, and the axis of ordinates represents the frequency f of laser beam 102. In other words, FIG. 4 illustrates a method of modulation of the optical frequency of the source 100 of sensor 1 for an acquisition of the distances from sensor 1 to the scene 110 to be imaged.

During the sub-phase C₁ of duration Tᵢ equal to T/4, frequency f is continuously and linearly modulated so that the excursion of the modulation is equal to B₁.

During the next sub-phase C₂ of duration T₂ equal to T/4, frequency f is continuously and linearly modulated so that the excursion of the modulation is equal to B₂, with B₂=B₁/K.

During the next sub-phase C₃ of duration T₃ equal to T/4, frequency f is continuously and linearly modulated so that the excursion of the modulation is equal to B₃, with B₃=B₁/K².

During the next sub-phase C₄ of duration T₄ equal to T/4, frequency f is continuously and linearly modulated so that the excursion of the modulation is equal to B₄, with B₄=B₁/K³.

In the example of FIG. 4, at each sub-phase (or chirp) Cᵢ, the optical frequency f of laser beam 102 is modulated from a same value fstart. This implies that, at the end of each sub-phase Cᵢ and before the beginning of the next sub-phase Cᵢ₊₁, frequency f has to be instantaneously taken back to frequency fstart, which strongly calls upon the response of source 100 and of its control circuit 118.

It is possible to implement sub-phases Cᵢ while avoiding fast returns of frequency f to frequency fstart.

For this, it is sufficient for the optical frequency fendᵢ of beam 102 at the end of each sub-phase Cᵢ to be equal to the frequency fstartᵢ₊₁ of beam 102 at the beginning of the next sub-phase Cᵢ₊₁.

However, this may result in the optical frequency f of laser beam 102 going through a very large frequency range, which is not desirable, or even in source 100 not being capable of modulating frequency f over the entire desired range. However, in each sub-phase Cᵢ, the frequency F_{Ri} measured for a distance z within range Dzᵢ actually depends on the absolute value of ratio Bᵢ/Tᵢ. Advantageously, it is then possible, in addition to providing for the frequency fendᵢ at the end of each sub-phase Cᵢ to be equal to frequency fstartᵢ₊₁ at the beginning of the next sub-phase Cᵢ₊₁, to provide for the sign, or the polarity, of coefficient Bᵢ to change at each beginning of a sub-phase Cᵢ or, in other words, at each change of sub-phase Cᵢ. In other words, considering that Bᵢ is a frequency excursion, and thus always positive, this amounts to providing for this frequency excursion to be run through in one direction or in the other, by alternating the variation direction for each sub-phase Cᵢ.

FIG. 5 illustrates the variation of the optical frequency f of beam 102 in an example of implementation where N is equal to 4, Tᵢ is identical for all sub-phases Cᵢ, Kᵢ is identical and equal to K for all sub-phases Cᵢ, and ΔF_{R}i is identical for all sub-phases Cᵢ. In FIG. 5, the frequency fendᵢ at the end of each sub-phase Cᵢ is equal to the frequency fstartᵢ₊₁ at the beginning of the next sub-phase Cᵢ₊₁, and the sign of coefficient Bᵢ, or, in other words, the direction in which frequency excursion Bᵢ is run through changes for each new sub-phase Cᵢ.

During the sub-phase C₁ of duration T₁, frequency f is continuously and linearly modulated so that the excursion of the modulation is equal (in absolute value) to B₁, and, more particularly, so that f varies linearly from fstart=fstartᵢ to fendᵢ. B₁ is, in this example, positive or, in other words, the frequency excursion B₁ is run through in the direction of increasing frequencies.

During the next sub-phase C₂ of duration T₂, frequency f is continuously and linearly modulated so that the excursion of the modulation is equal (in absolute value) to B₂, and, more particularly, so that f varies linearly from fstart₂=fendᵢ to fend₂. B₂ is, in this example, negative, or, in other words, the frequency excursion B₂ is run through in the direction of decreasing frequencies.

During the next sub-phase C₃ of duration T₃, frequency f is continuously and linearly modulated so that the excursion of the modulation is equal (in absolute value) to B₃, and, more particularly, so that frequency f varies linearly from fstart₃=fend₂ to fend₃. B₃ is, in this example, positive or, in other words, frequency excursion B₃ is run through in the direction of increasing frequencies.

During the next sub-phase C₄ of duration T₄, frequency f is continuously and linearly modulated so that the excursion of the modulation is equal (in absolute value) to B₄, and, more particularly, so that frequency f varies linearly from fstart₄=fend₃ to fend₄. B₄ is, in this example, negative, or, in other words, the frequency excursion B₄ is run through in the direction of decreasing frequencies

More generally, according to an embodiment, for i odd, fstartᵢ=fstartᵢ₋₁−Bᵢ₋₁, and, for i even, fstartᵢ=fstartᵢ₋₁+Bᵢ₋₁.

As an alternative example, not illustrated, coefficient B₁ may be negative or, in other words, frequency excursion B₁ may be run through in the direction of decreasing frequencies.

A specific numerical example will now be described. In this example, there is considered a case where:
duration T is equal to 200 μs,
the minimum distance zmin (equal to zmin1) to be detected is equal to 0.3 m,
the maximum distance zmax (equal to zmaxN) to be detected is equal to 10 m,
durations Ti are all identical,
coefficients Ki are all identical and equal to K=2, and
the frequencies FRinfi of sub-phases Ci are all equal to 75 KHz.

As a result:
dynamic range zmax_{N}/zmin₁ is equal to 33.33,
N is equal to 5,
each duration Tᵢ is equal to 200 μs divided by N, that is, 40 μs,
frequencies F_{R}supᵢ are all equal to 150 KHz,
bandwidths ΔF_{Ri} are all equal to 75 KHz,
B₁ is equal to 1.5*10⁹ Hz (B₁=(F_{R}inf₁*c*T₁)/(2*zmin₁)),
sub-phase C₁ enables to detect the distances z in the range from zmin₁=0.30 m to zmax₁=0.60 m,
B₂ is equal to 750*10⁶ Hz (B₂=B₁/K),
sub-phase C₂ enables to detect the distances z in the range from zmin₂=0.60 m to zmax₂=1.20 m,
B₃ is equal to 375*10⁶ Hz (B₃=B₁/K²),
sub-phase C₃ enables to detect the distances z in the range from zmin₃=1.20 m to zmax₃=2.40 m,
B₄ is equal to 187.5*10⁶ Hz (B₄=B₁/K³),
sub-phase C₄ enables to detect the distances z in the range from zmin₄=2.40 m to zmax₄=4.80 m, and
B₅ is equal to 93.750*10⁶ Hz (B₄=B₁/K⁴),
sub-phase C₅ enables to detect the distances z in the range from zmin₅=4.80 m to zmax₅=9.60 m.

In the above example, the placing end to end of measurement ranges Dz₁ to Dz₅ does not exactly span the entire targeted measurement range from zmin to zmax since value N has been selected to be equal to the integer value just below the base-K logarithm of zmax/zmin. However, in another example where value N is selected to be equal to the integer value just above the base-K logarithm of zmax/zmin, the placing end to end of ranges Dzᵢ to Dz₅ spans the entire targeted measurement range from zmin to zmax, and even more.

If it had been desired to obtain the same z measurement range from zmin to zmax with a single continuous phase of modulation of the optical frequency f of laser 102 during time period T and with a minimum beat frequency F_{R}min equal to 75 KHz, this would have implied selecting a coefficient B equal to 7.5*10⁹ Hz (N times greater than coefficient Bᵢ). Such a value of coefficient B would have resulted in providing a maximum beat frequency F_{R}max equal to 2.5 MHz, which would have resulted in a bandwidth ΔF_{R}=2.43 MHz, and thus in a signal-to-noise ratio approximately 5.69 times smaller than in the case of the previous example.

For each sub-phase Cᵢ and each pixel of the sensor, the point associated with the pixel is at a distance z within the range Dzᵢ of sub-phase Cᵢ if the measured frequency F_{R}i is between F_{R}infᵢ and F_{R}supᵢ, and thus if the number M of periods Te of the heterodyne signal of the pixel counted during duration Tᵢ is in a range of values ranging from Mminᵢ to Mmaxᵢ, with Mminᵢ=Tᵢ*F_{R}infᵢ and Mmaxᵢ=Tᵢ*F_{R}supᵢ. When frequencies F_{R}infᵢ are identical for all sub-phases Cᵢ, F_{R}supᵢ are identical for all sub-phases Cᵢ, and durations Tᵢ are identical for all sub-phases Cᵢ, numbers Mminᵢ and Mmaxᵢ are identical for all sub-phases Cᵢ and respectively equal to Mmin and Mmax. With the above specific numerical example, Mmin=3 and Mmax=6.

In the above example, it has been chosen to set value F_{R}infᵢ rather than the minimum number Mmin of periods to be detected in each sub-phase Cᵢ, although it would also have been possible to set value Mmin equal to 3 rather than value F_{R}infᵢ. Taking the above example, and setting Mmin equal to 3, this implies that F_{R}infᵢ=Mmin/Tᵢ=3/(40*10-⁶)=75 KHz and the same results are thus obtained.

In each sub-phase Cᵢ, the number M of periods of the heterodyne signal may be obtained by means of a counter which accumulates, or counts, the number of periods of the heterodyne signal for the duration Tᵢ of sub-phase Cᵢ. In this case, number M is an integer, and the uncertainty or error on number M is equal to more or less 1. As a result, the distance measurement resolution in each sub-range Cᵢ is equal to ∂zᵢ=c/(2*Bᵢ).

Knowing that, in each sub-phase Ci, zmaxᵢ=Kᵢ*zminᵢ, with Kᵢ equal to K in all sub-ranges Cᵢ, if it is desired for the extension of the measurement range Dzᵢ of each sub-phase Cᵢ to be equal to the resolution ∂zᵢ of this sub-range, then zminᵢ=c/(2*Bᵢ*(K−1))=∂zᵢ/(K−1), and thus ∂zᵢ=zminᵢ*(K−1). Now, zminᵢ=(c*Mmin)/(2*Bᵢ), whereby Mmin=1/(K−1) and Mmax=K/(K−1). It is then possible to select a resolution and to deduce therefrom the corresponding value K, and then the values Mmin and Mmax corresponding to this value of K.

For example, if a resolution ∂zᵢ is targeted in each range Cᵢ which is equal to 1% of the minimum value zminᵢ of this range Cᵢ, this implies that K−1=0.01, and thus that K=1.01, Mmin =1/(K−1)=100 and Mmax=K/(K−1)=101.

In the above example, the number M of periods is obtained by means of an integer counter, whereby the error on the value of number M is equal to plus or minus 1, and thus the resolution for z, ∂zᵢ, is equal to c/(2*Bᵢ). In other examples, number M may be obtained by means of a counter with a double time base enabling to measure a fractional portion of number M, which enables to decrease the error on the value of M, and thus to increase the resolution.

More generally, for an error E on the determination of number M by counting, the resolution for z, ∂zᵢ, is equal to (E*c)/(2*Bᵢ). By choosing for the extension of the measurement range Dzᵢ of each sub-phase Cᵢ to be equal to the resolution ∂zᵢ of this sub-range (that is, ∂zᵢ=(K-1)*zminᵢ), then Mmin=E/(K−1) and Mmax=(E*K)/(K−1). Thus, as previously, by setting resolution ∂zᵢ, and knowing error E, it is possible to deduce therefrom the corresponding value K, and then the values Mmin and Mmax corresponding to this value of K.

The above examples show that the lower the resolution ∂zᵢ in each sub-range Cᵢ, in percentage of the minimum value zminᵢ detectable in this sub-range, the more the number N of sub-phases increases for a given measurement dynamic range zmax−zmin. Thus, small values of resolution ∂zᵢ may result in a number N of sub-phases which is not compatible with an operation in rolling mode and a rate of acquisition of the scene compatible with a video application, that is, a rate of acquisition of the scene of at least 30 images of the scene per second. However, small resolution values ∂zᵢ and the numbers N of sub-phases to which they correspond may remain compatible with an operation in snapshot mode. As a specific numerical example, there is considered a case where:
duration T is equal to 33 ms, so that the sensor can acquire 30.3 frames per second, which is compatible with a video application,
the minimum distance zmin (equal to zmin₁) to be detected is equal to 0.3 m,
the maximum distance zmax (equal to zmax_{N}) to be detected is equal to 10 m,
durations Tᵢ are all identical,
coefficients Kᵢ are all identical and equal to K,
the frequencies F_{R}infᵢ of sub-phases Cᵢ are all equal, and
in each sub-range Cᵢ, ∂zᵢ is equal to 1% of zminᵢ.

As a result:
dynamic range zmax_{N}/zmin₁ is equal to 33.3,
K is equal to 1.01, which implies that Mmin=100 and Mmax=101,
N is equal to 352,
each duration Ti is equal to 93.75 μs,
frequencies F_{R}infᵢ are all equal to Mmin/Tᵢ=1.07 MHz,
frequencies F_{R}supᵢ are all equal to Mmax/Tᵢ=1.08 MHz,
bandwidths ΔF_{Ri} are all equal to 10.10 KHz,
B₁ is equal to 50*10⁹ Hz (B₁=(F_{R}infₗ*c*T₁)/(2*zminᵢ)), the other coefficients Bᵢ being equal to B₁/Kⁱ⁻¹,
sub-phase C₁ enables to detect the distances z in the range from zminᵢ=0.30000 m to zmax₁=0.30300 m,
sub-phase C₂ enables to detect the distances z in the range from zmin₂=0.30300 m to zmax₂=0.30603 m,
sub-phase C₃ enables to detect the distances z in the range from zmin₃=0.30603 m to zmax₃=0.30909 m,
sub-phase C₃₅₁ enables to detect the distances z in the range from zmin₃₅₁=9.76342 m to zmax₃₅₁=9.86106 m, and
sub-phase C₃₅₂ enables to detect the distances z in the range from zmin₃₅₂=9.86106 m to zmax₃₅₂ =9.95967 m.

If it had been desired to obtain the same z measurement range from zmin to zmax with a single continuous phase of modulation of the optical frequency f of laser 102 during time period T and with a minimum beat frequency F_{R}min equal to 1.07 MHz, this would have implied selecting a coefficient B equal to 17.6*10¹² Hz (N times greater than the coefficient B₁ of the above example). Such a value of coefficient B would have resulted in providing a maximum beat frequency F_{R}max equal to 35.56 MHz, which would have resulted in a bandwidth ΔF_{R}=34.5 MHz, and thus in a signal-to-noise ratio approximately 56 times smaller than in the case of the previous example.

In the above examples where, in each sub-phase Cᵢ, considering any pixel of the sensor, the range of values Dzᵢ measurable by this pixel during sub-phase Cᵢ is equal to resolution ∂zᵢ, the beat frequency F_{R}i to be measured in each sub-range Cᵢ for a point in the scene associated with the pixel to be at a distance within range Dzᵢ is almost constant, since the bandwidth is equal to the desired accuracy. It is thus sufficient to count Mmin periods of the heterodyne signal or to detect, by filtering of the heterodyne signal, a beat frequency between F_{R}infᵢ and F_{R}supᵢ, for example a frequency equal to (F_{R}supᵢ+F_{R}infᵢ)/2, to determine at what distance the object is located.

In examples where, for each sub-phase Cᵢ, the determination that a point in the scene is at a distance z within range Dzᵢ is implemented by detecting a single frequency between F_{R}infᵢ and F_{R}supᵢ, it is possible that, for a given pixel, this frequency is detected for at least two different sub-phases Ci, for example due to the noise present in the heterodyne signal, even filtered at the detection frequency. In this case, the signal level can enable to determine which of the sub-phases phases Cᵢ corresponds to the range Dzᵢ comprising the distance z between the pixel and its associated point, this sub-phase then being that for which the signal level is the highest.

Implementations where the range of values Dzᵢ measurable during each sub-phase Cᵢ is equal to resolution ∂zᵢ are for example well adapted to an operation in snapshot mode of the sensor. Further, these implementations are for example well adapted to sensors with an architecture called “event-based”, where each pixel sends an event signal only when it has counted M=Mmin for the current sub-phase Cᵢ, or only when it has detected for the current sub-phase Cᵢ a given frequency between F_{R}infᵢ and F_{R}supᵢ in the heterodyne signal filtered at this given frequency.

Embodiments where durations Tᵢ are all identical have been described hereabove.

In alternative embodiments, the excursions Bᵢ are all identical and the durations Tᵢ are different for each sub-phase Cᵢ. The implementation of such variants is within the abilities of those skilled in the art by adapting the previously described calculations.

In still other alternative embodiments, durations Tᵢ are fixed and excursions Bᵢ are variable for some of sub-phases Cᵢ, and durations Tᵢ are variable and excursions Bᵢ are fixed for the other sub-phases Cᵢ. Here again, the implementation of these variants is within the abilities of those skilled in the art by adapting the previously described calculations.

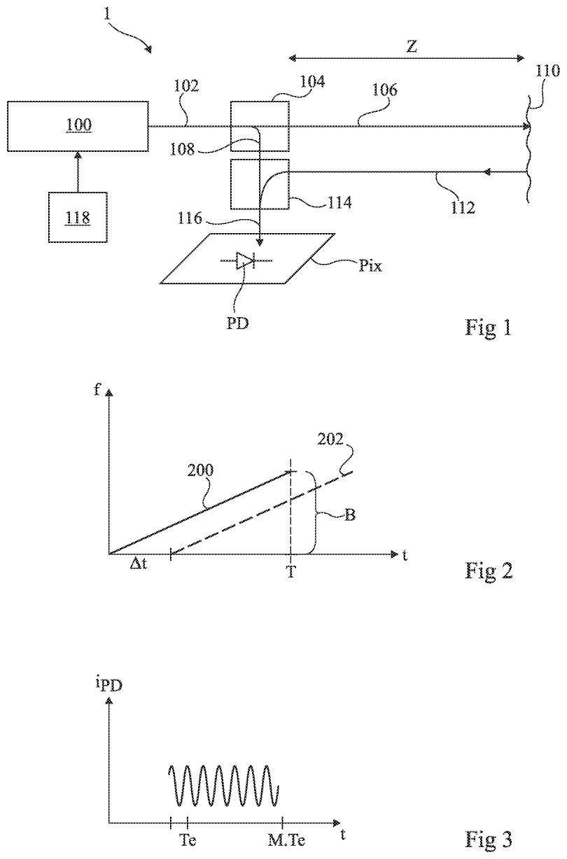

The acquisition of the distances from sensor 1 to the scene to be imaged by the implementation of a plurality of sub-ranges Cᵢ having different coefficients Bᵢ/Tᵢ may for example be implemented after a first acquisition of the scene to be imaged performed with a single B/T ratio, as described in relation with FIGS. 1, 2, and 3. Thus, during the first acquisition of the scene performed with the B/T ratio, a circuit of sensor 1, for example, a calculation and/or processing circuit, determines an adapted measurement dynamic range zmax-zmin and calculates coefficients Bᵢ/Tᵢ by taking into account the determined adapted dynamic range. Sensor 1 then implements a second acquisition of the scene comprising a plurality of sub-phases Cᵢ determined by the coefficients Bᵢ/Tᵢ calculated by taking into account the adapted dynamic range.

More generally, coefficients Bᵢ/Tᵢ may be calculated during a design phase and recorded in the sensor to be used therein at each acquisition of a scene, or the sensor may comprise a calculation circuit configured to recalculate coefficients Bᵢ/Tᵢ at each modification of a parameter such as the targeted dynamic range zmax-zmin, the frequency F_{R}infᵢ of sub-ranges Cᵢ, number Mmin, etc.

FIG. 6 schematically shows an embodiment of a sensor 2 implementing the method of FIG. 4 or of FIG. 5.

Although this is not shown in FIG. 6, sensor 2 comprises, like the sensor 1 of FIG. 1, a source 100 of a laser beam 102, a circuit 118 for controlling source 100, that is, the optical frequency f of laser beam 102, and the optical devices 104 and 114 enabling to supply beams 106, 108, and 116 from beam 102 and the reflected beam 112.

Further, in FIG. 6, a single pixel Pix of sensor 2 is shown although, in practice, sensor 2 for example comprises a large number of pixels Pix, for example, at least 100,00 pixels Pix, pixels Pix then being arranged in an array comprising rows of pixels Pix and columns of pixels Pix.

According to an embodiment, during a phase of capture of a scene, sensor 2 is configured so that, at each sub-phase Cᵢ, beam 116 simultaneously illuminates all the pixels Pix of sensor 2.

In the embodiment of FIG. 6, the architecture of pixel Pix is for example adapted to an operation of the sensor in rolling mode.

Pixel Pix comprises a photodetector PD configured to receive the portion of beam 116 (FIG. 1) corresponding to the point in the scene imaged by this pixel Pix, that is, the point in the scene associated with pixel Pix.

Photodetector PD is configured to supply heterodyne signal i_{PD}.

According to an embodiment, pixel Pix comprises a circuit 600 (block AF in FIG. 6) configured to filter and amplify signal iPD, the bandwidth of circuit 600 then being greater than or equal to, preferably equal to, the largest of bandwidths ΔF_{R}i, for example to any of bandwidths ΔF_{R}i, when they are all identical. Circuit 600 receives signal i_{PD} and supplies a signal I_{PD}corresponding to signal i_{PD} filtered and amplified.

According to an embodiment, pixel Pix further comprises a comparator COMP configured to supply a binary signal COMPout at ‘1’ when signal I_{PD} is greater than a value, and at ‘0’ otherwise. Thus, when analog signal I_{PD} exhibits oscillations, binary signal COMPout oscillates at the same frequency.

Pixel Pix further comprises a row selection switch SEL. When switch SEL is on, in practice simultaneously for all the pixels Pix of a same row, the output signal of pixel Pix is supplied to a conductive row 602 common to all the pixels Pix of a same column. When switch SEL is off (row of pixels Pix deselected), conductive line 602 receives the output signal of a pixel of the same column but of another pixel row, that is, the selected row of pixels Pix.

In the embodiment of FIG. 6 where each pixel Pix comprises circuit 600 and circuit COMP, the output signal of pixel Pix is signal COMPout.

In each column, conductive line 602 is connected to a corresponding readout circuit 604, for example, arranged at the foot of a column. This circuit 604 receives the output signal of the pixel Pix of the column which has its switch SEL on. Circuit 604 is configured, at each sub-phase Cᵢ, for example, at each time period Tᵢ, to count the number M of periods of signal i_{PD} of the pixel Pix coupled to row 602 by its switch SEL.

In the embodiment of FIG. 6 where each pixel Pix comprises a circuit 600 and a circuit COMP, according to an embodiment where the sensor operates in rolling mode, circuit 604 is configured to count, at each sub-phase Cᵢ, for example, for each time period Tᵢ, the number M of periods of signal COMPout that it receives.

As an example, circuit 604 then comprises a counter 606 (block “COUNTER” in FIG. 6), which receives the output signal of the selected pixel Pix. Circuit 606 is configured to increment at each pulse of the output signal during the duration Tᵢ of each phase Cᵢ. Counter 606 is further configured to reset at the beginning of each phase Cᵢ.

Optionally, circuit 604 may further comprise a circuit 608 (block “REG” in FIG. 6) configured to store, at the end of each sub-phase Cᵢ, the number M counted during this sub-phase Cᵢ. As an example, circuit 608 is a register, for example, a shift register. Thereby, the reading of the numbers M counted by all the circuits 604 of the sensor during a sub-phase Cᵢ and stored at the end of this sub-phase Cᵢ may be read, for example, sequentially, during the next sub-phase Cᵢ₊₁.

In an alternative embodiment, pixels Pix are deprived of circuits COMP but comprise circuits 600. In this case, the output signals of pixels Pix are signals I_{PD}. Each circuit 604 then receives an output signal I_{PD} of the pixel Pix selected from the column of circuit 604. Each circuit 604 then comprises a circuit COMP receiving the output signal I_{PD} of pixel Pix and supplying the corresponding signal COMPout used by circuit 604, for example, by its counter 606, to count number M at each sub-phase Cᵢ.

In still another alternative embodiment, pixels Pix are deprived of circuits COMP and of circuits 600. In this case, the output signals of pixels Pix are signals I_{PD}. Each circuit 604 then receives the output signal i_{PD} of the pixel Pix selected in the column of circuit 604. Each circuit 604 then comprises a circuit 600 receiving the output signal i_{PD} of pixel Pix and supplying the corresponding signal I_{PD}. Each circuit 604 further comprises a circuit COMP receiving the signal IPD supplied by the circuit 600 of circuit 604 and supplying the signal COMPout used by circuit 604, for example, by its counter 606, to count number M at each sub-phase Cᵢ.

Although this is not illustrated in FIG. 6, sensor 2 may comprise one or a plurality of circuits configured to deactivate or turn off pixels Pix of sensor 2 which are not used, that is, which are not measured or, in other words, which are not implementing a measurement of distance z. For example, the pixels Pix of the non-selected rows may be deactivated or turned off to decrease the power consumption. As an alternative or complementary example, when at a sub-phase Cᵢ, the numbers M counted for pixels Pix of the selected row indicate that these pixels are at distances z from their associated points which belong to the corresponding range Dzᵢ, then these pixels Pix may be deactivated or turned off for the next sub-phases Cᵢ.

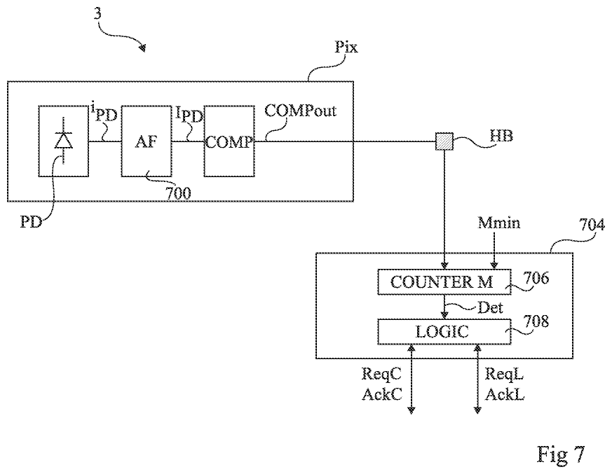

FIG. 7 schematically shows another embodiment of a sensor 3 implementing the method of FIG. 4 or of FIG. 5.

Although this is not shown in FIG. 7, sensor 3 comprises, like the sensor 1 of FIG. 1 and the sensor 2 of FIG. 6, a source 100 of a laser beam 102, a circuit 118 for controlling source 100, that is, the optical frequency f of laser beam 102, and optical devices 104 and 114 enabling to supply beams 106, 108, and 116 from beam 102 and the reflected beam 112.

In FIG. 7, as in FIG. 6, a single pixel Pix of sensor 3 is shown although, in practice, sensor 3 for example comprises a large number of pixels Pix, for example, at least 100,000 pixels Pix, pixels Pix then being arranged in an array comprising rows of pixels Pix and columns of pixels Pix.

According to an embodiment, during a phase of capture of a scene, sensor 3 is configured so that, at each sub-phase Cᵢ, beam 116 simultaneously illuminates all the pixels Pix of sensor 3.

Pixel Pix comprises a photodetector PD configured to receive the portion of beam 116 (FIG. 1) corresponding to the point in the scene imaged by this pixel Pix, that is, the point associated with pixel Pix.

Photodetector PD is configured to supply heterodyne signal i_{PD}.

In the embodiment of FIG. 3, the architecture of pixel Pix is for example adapted to an operation of the sensor in snapshot mode. Further, in the example of FIG. 7, coefficients Bᵢ/Tᵢ have been calculated so that, for each sub-phase Cᵢ, Dzᵢ=∂zᵢ.

According to an embodiment, pixel Pix comprises circuit 700 (block AF in FIG. 7) configured to filter and amplify signal iPD, the bandwidth of circuit 700 then being greater than or equal to, preferably equal to, the largest of bandwidths ΔF_{R}i, for example, to any of bandwidths ΔF_{R}i, when they are all identical. Circuit 700 receives signal i_{PD} and supplies a signal I_{PD}corresponding to signal i_{PD} filtered and amplified.

According to an embodiment, pixel Pix further comprises a comparator COMP configured to supply a binary signal COMPout at ‘1’ when signal I_{PD} is greater than a value, and at ‘0’ otherwise. Thus, when analog signal I_{PD} exhibits oscillations, binary signal COMPout oscillates at the same frequency.

In the embodiment of FIG. 7 where each pixel Pix comprises circuit 700 and circuit COMP, the output signal of pixel Pix is signal COMPout.

Sensor 3 further comprises, for each pixel Pix, a readout circuit 704 associated with this pixel Pix. Thus, sensor 3 comprises as many circuits 704 as pixels Pix.

According to an embodiment, the pixel array Pix of sensor 3 is implemented inside and of top of a first semiconductor layer, for example inside and on top of a first semiconductor substrate, and circuits 704 are implemented, for example in array form, inside and on top of a second semiconductor layer, for example, a semiconductor-on-insulator layer. The two semiconductor layers are each coated with a back-end-of-line (BOEL) interconnection structure, the two interconnection structures being assembled to each other, for example, by molecular bonding HB as illustrated in FIG. 7, to couple, for example, connect, each pixel Pix to its circuit 704. According to another embodiment, the pixels Pix and their readout circuits 704 are all implemented inside and on top of a same semiconductor layer.

Each circuit 704 receives the output signal of pixel Pix which is associated therewith. Each circuit 704 is configured, at each sub-phase Cᵢ, for example for each time period Tᵢ, to count the number M of periods of signal i_{PD} of the pixel Pix with which it is associated, for example, by counting the number of periods of the output signal of pixel Pix. In this example where, at each phase Cᵢ and for each pixel Pix, it is desired to determine whether the number M of periods of the heterodyne signal of pixel Pix is equal to Mmin, each circuit 704 is configured to detect, at each sub-phase Cᵢ, whether the counted number M is equal to Mmin.

In the embodiment of FIG. 7 where each pixel Pix comprises a circuit 700 and a circuit COMP, each circuit 704 is configured to count, at each phase Cᵢ, for example, at each duration Tᵢ, the number M of periods of signal COMPout that it receives from its associated pixel Pix.

As an example, circuit 704 comprises a counter 706 (block “COUNTER M” in FIG. 7). Circuit 706 is configured for the number M of pulses of signal COMPout during the duration Tᵢ of each sub-phase Cᵢ, and to supply an output signal Det indicating when number M is equal to Mmin. For this purpose, circuit 704, and more particularly its circuit 706, for example comprise an input configured to receive the value of Mmin. Counter 706 is further configured to reset at the beginning of each sub-phase Cᵢ.

To enable the reading of pixels Pix according to an event-based logic, each circuit 704 further comprises a circuit 708 (block “LOGIC” in FIG. 7). Circuit 708 is configured to receive signal Det, and to supply at least one event signal to a processing circuit of sensor 3 if, for the current phase Cᵢ, the number M counted for the pixel Pix which is associated therewith is equal to Mmin. As an example, this event signal indicates to the processing circuit of sensor 3, also called event management circuit, the row and the column of the array to which pixel Pix belongs, that is, the position of pixel Pix.

As an example, at each sub-phase Cᵢ, each circuit 708 is configured, when number M is equal to (or reaches) Mmin, to supply the event signal ReqC indicating the column to which the pixel Pix associated with circuit 708 belongs, and an event signal ReqL indicating the row to which the pixel Pix associated with this circuit 708 belongs. These signals are supplied to the event management circuit of sensor 3. For example, the event management circuit comprises a column event management circuit receiving signal ReqC, and a row event management circuit receiving signal ReqL.

As an example, the event management circuit is configured to send at least one acknowledgement signal to circuit 708 to indicate thereto that it has effectively received signals ReqC and ReqL. For example, the event management circuit is configured to send an acknowledgement signal AckC to circuit 708 to indicate thereto that it has effectively received signal ReqC, and to send acknowledgement signal AckL to circuit 708 to indicate thereto that it has effectively received signal ReqL. As an example, signal AckC is supplied by the column event management circuit, and signal AckL is supplied by the row event management circuit.

As a more specific example, for each pixel Pix, when pixel Pix detects that M=Mmin, the sequence of request and acknowledgement signals is the following:
sending of signal ReqC,
reception of the corresponding signal AckC,
sending of signal ReqL, and
reception of the corresponding signal AckL.

According to an embodiment, when a pixel Pix has received the two acknowledgement signals AckL and AckC, it may switch to a standby state that it will only leave at the beginning of the next capture phase. As an example, a pixel Pix in the standby state deactivates at least its circuit 708, or even all its circuits 700, COMP, and 704.

In an alternative embodiment, pixels Pix are deprived of circuits COMP but comprise circuits 700. In this case, the output signals of pixels Pix are signals I_{PD}. Each circuit 704 then receives the output signal I_{PD} of the corresponding pixel Pix. Each circuit 704 then comprises a circuit COMP receiving the output signal I_{PD} of pixel Pix and supplying the corresponding signal COMPout used by circuit 704, for example, by its counter 706, to count number M at each phase Cᵢ.

In still another alternative embodiment, pixels Pix are deprived of circuits COMP and of circuits 700. In this case, the output signals of pixels Pix are signals I_{PD}. Each circuit 704 then receives the output signal i_{PD} of the corresponding pixel Pix. Each circuit 704 then comprises a circuit 700 receiving the output signal i_{PD} of pixel Pix and supplying the corresponding signal I_{PD}. Each circuit 704 further comprises a circuit COMP receiving the signal I_{PD} supplied by the circuit 700 of circuit 704 and supplying the signal COMPout used by circuit 704, for example, by its counter 706, to count number M at each sub-phase Cᵢ.

As an example, an event-based reading of the pixels implies a classification of the pixels by increasing (or decreasing) order according to the detected distance. In the mentioned examples, short distances are explored first to end with long distance (the inverse is also possible). In such an example, the addition of a counter which counts the number of pixels read after each sub-phase Cᵢ and of a circuit, for example, a register or a memory, storing the number of pixels counted at each sub-phase Cᵢ, makes it possible to obtain a histogram of distances in real time. Indeed, the obtaining of this histogram does not require supplying the addresses of each pixel and the reading of the pixels can thus be performed more rapidly. The histogram thus obtained may be used to, for example, readjust the ramp sequence (that is, ratios Bᵢ/Tᵢ) to better target a distance range when it can be observed that the complete dynamic range is not used.

Similarly, once the N sub-phases Cᵢ have been implemented, the ramp sequence may be adapted to target the measurement on an accurate distance, that is, by performing a new capture but only with a single sub-phase Cᵢ corresponding to this accurate distance.

Various embodiments and variants have been described. Those skilled in the art will understand that certain features of these various embodiments and variants may be combined, and other variants will occur to those skilled in the art. In particular, although in most previously-described embodiments and variants, the counted number M of periods of the heterodyne signal of a pixel Pix is an integer number, those skilled in the art are capable of providing more accurate counters, for example, with a double time base, enabling to count not only a number of entire periods of the heterodyne signal for a given duration, but further, the fractional portion of the number of periods of the heterodyne signal during this determined duration.

Finally, the practical implementation of the described embodiments and variations is within the abilities of those skilled in the art based on the functional indications given hereabove.

1. Method of acquisition of distances from a sensor to a scene, the method comprising, during a phase of capture of the scene, a number N of consecutive capture sub-phases Cᵢ, with N an integer greater than or equal to 2 and i an integer index ranging from 1 to N, each of the capture sub-phases Cᵢ comprising:
the supplying of a laser beam having an optical frequency linearly varying over a frequency range of width Bᵢ for a time period Tᵢ;
the supplying from said laser beam of a reference beam and of a useful beam; and
the illumination of the scene by the useful beam and the illumination of at least one row of pixels of the sensor by a beam corresponding to a superposition of the reference beam and of a reflected beam corresponding to the reflection of the useful beam by the scene,
wherein an absolute value of a ratio Bᵢ/Tᵢ is different for each capture sub-phase Cᵢ,
wherein each capture sub-phase Cᵢ corresponds to a range Dzᵢ of measurement of distances from the sensor to the scene, range Dzᵢ ranging from zminᵢ to zmaxᵢ with zmaxᵢ greater than zminᵢ, ratios Bᵢ/Tᵢ being determined so that for i varying from 1 to N−1, zminᵢ+i is substantially equal to zmaxᵢ without being greater than zmaxᵢ.

2. Method according to claim 1, where ratios Bᵢ/Tᵢ are determined so that for i ranging from 1 to N−1 zminᵢ₊₁ is equal to zmaxᵢ.

3. Method according to claim 1, wherein, for each measurement sub-phase Cᵢ and for each pixel of the sensor, the illumination of the pixel by the beam corresponding to the superposition of the reference beam and of the reflected beam results in a signal oscillating at a beat frequency F_{Ri} belonging to a range ΔF_{Ri} of frequencies ranging from a frequency F_{R}infᵢ to a frequency F_{R}supᵢ if a point in the scene associated with said pixel is at a distance from the pixel within range Dzᵢ.

4. Method according to claim 3, wherein, for i ranging from 1 to N, F_{R}supᵢ is equal to Kᵢ times F_{R}infᵢ, with Kᵢ a coefficient, and frequency F_{R}infᵢ is identical for all indexes i in the range from 1 to N.

5. Method according to claim 4, wherein Kᵢ is identical for all indexes i in the range from 1 to N.

6. Method according to claim 3, wherein for each capture sub-phase Cᵢ and each pixel of the sensor, if the beat frequency F_{Ri} is within frequency range ΔF_{Ri}, a distance z from the pixel to the point in the scene associated with the pixel is calculated based on the following formula:
z=(c·Tᵢ·F_{Ri})/(2·Bᵢ), with c the speed of light.

7. Method according to claim 3, wherein for each pixel and at each capture sub-phase Cᵢ, a measurement of the frequency F_{Ri} of a pixel is obtained by counting, during the duration Tᵢ of said sub-phase Cᵢ, a number of periods of the oscillating signal of said pixel.

8. Method according to claim 7, wherein, for each pixel and for each capture sub-phase Cᵢ, the pixel is at a distance from the point in the scene associated with this pixel within measurement range Dzᵢ if the number of periods counted during the duration Tᵢ of sub-phase Cᵢ belongs to a range of values ranging from a low value Mminᵢ to a high value Mmaxᵢ, the low value being equal to Tᵢ*F_{R}infᵢ and the high value being equal to Tᵢ*F_{R}supᵢ.

9. Method according to claim 2, wherein, for i ranging from 1 to N, each range Dzᵢ has a width equal to a targeted distance measurement resolution.

10. Method according to claim 8, wherein, for i ranging from 1 to N, each range Dzᵢ has a width equal to a targeted distance measurement resolution, and, for each pixel and for each capture sub-phase Cᵢ, the pixel is at a distance from the point in the scene associated with this pixel within measurement range Dzᵢ if the number of periods counted during the duration Tᵢ of sub-phase Cᵢ is equal to a number determined by this targeted resolution.

11. Method according to claim 6, wherein each range Dzᵢ has a width equal to a targeted distance measurement resolution, and, for each pixel and for each capture sub-phase Cᵢ, a determination that the beat frequency F_{Ri} is within frequency range ΔF_{Ri} is performed by detecting a given frequency of range ΔF_{Ri}.

12. Method according to claim 1, wherein, for i ranging from 1 to N, Tᵢ is equal to T/N with T a duration of a phase of simultaneous acquisition by all the sensor pixels, or of a phase of acquisition by a single pixel row of a pixel array of the sensor.

13. Method according to claim 1, wherein, for each capture sub-phase Ci, the optical frequency of the laser beam varies from fstarti to fendi, for i ranging from 1 to N−1, fendi equal to fstarti+1 and a sign of coefficient Bi/Ti changes at each passage from a current capture sub-phase Ci to a next capture sub-phase Ci.

14. Sensor configured to implement the method according to claim 1, the sensor comprising:
an array of pixels,
a source of a laser beam,
an optical device configured to supply a reference beam and a useful beam intended to illuminate a scene to be captured,
an optical device configured to simultaneously supply at least one pixel row with a beam corresponding to a superposition of the reference beam and of a beam reflected by the scene when it is illuminated by the useful beam, and
a circuit for controlling the source, configured to modulate an optical frequency of the laser beam supplied by the source so that at each capture sub-phase Cᵢ, the optical frequency of the beam varies linearly over the frequency range of width Bᵢ during time period Tᵢ.

15. Sensor comprising:
an array of pixels;
a source of a laser beam;
an optical device configured to supply a reference beam and a useful beam intended to illuminate a scene to be captured;
an optical device configured to simultaneously supply all the pixels with a beam corresponding to a superposition of the reference beam and of a beam reflected by the scene when it is illuminated by the useful beam; and
a circuit for controlling the source, configured to modulate an optical frequency of the laser beam supplied by the source so that at each capture sub-phase Cᵢ, the optical frequency of the beam varies linearly over the frequency range of width Bi during time period Ti;
the sensor being configured to implement the method according to claim 11 and comprising an event management circuit, and
each pixel comprising a circuit configured to detect the given frequency and a circuit configured to deliver at least one event signal to the event management circuit if, during a sub-phase Ci, the given frequency is detected.

16. Sensor comprising:
an array of pixels;
a source of a laser beam;
an optical device configured to supply a reference beam and a useful beam intended to illuminate a scene to be captured;
an optical device configured to simultaneously supply all the pixels with a beam corresponding to a superposition of the reference beam and of a beam reflected by the scene when it is illuminated by the useful beam; and
a circuit for controlling the source, configured to modulate an optical frequency of the laser beam supplied by the source so that at each capture sub-phase Ci, the optical frequency of the beam varies linearly over the frequency range of width Bi during time period Ti;
the sensor being configured to implement the method according to claim 10 and comprising an event management circuit, and
each pixel comprising a circuit configured to supply at least one event signal to the event management circuit if, during a sub-phase Ci, the number of periods counted during the duration Ti of sub-phase Ci is equal to the number determined by the targeted resolution.
